(19) United States
(12) Patent Application Publication
(10) Pub. No.: US 2025/0062656 A1
(43) Pub. Date: Feb. 20, 2025

(54) DRIVING-POWER-OUTPUTTING FLYWHEEL DEVICE

(71) Applicant: RI DON VEHICLES CO., LTD., Kaohsiung City (TW)

(72) Inventor: TSUNG YI TSAI, Kaohsiung City (TW)

(73) Assignee: RI DON VEHICLES CO., LTD., Kaohsiung City (TW)

(21) Appl. No.: 18/801,966

(22) Filed: Aug. 13, 2024

(30) Foreign Application Priority Data
Aug. 17, 2023 (TW) 112130950

(51) Int. Cl. H02K 7/02; H02K 7/08; H02K 7/14

(52) U.S. Cl. CPC H02K 7/025; H02K 7/08; H02K 7/14

(57) ABSTRACT

A driving-power-outputting flywheel device comprises a power-supply-and-controlling module, an electrical motor, a one-way transmission assembly, a flywheel assembly, and a driving-power-outputting unit. The power-supply-and-controlling module connects an electrical-power source, and supplies power to and control the electrical motor. The electrical motor, a motor-connecting shaft and a one-way bearing of one-way transmission assembly, the flywheel assembly, and the driving-power-outputting unit connect in sequence, so the driving-power-outputting unit is driven by the electrical motor. The electrical motor rotates the flywheel assembly through the one-way transmission assembly, and the flywheel assembly hence starts inertial motions and stores energy. Therefore, when starting the driving-power-outputting unit, pre-stored energy in the flywheel assembly reduces the starting current to reduce power consumption for starting the driving-power-outputting unit, thereby saving electrical power and being environmentally friendly.

### 1. FIELD OF THE INVENTION

The present invention relates to a driving-power-outputting flywheel device, especially to a driving-power-outputting device that can reduce power consumption by using the inertial force generated by a rotating flywheel assembly to reduce a required starting power of a driving-power-outputting unit connected to the flywheel assembly.

### 2. Description of Related Art

A conventional driving-power-outputting device comprises a driving-power-outputting unit and an electrical motor. The driving-power-outputting unit is a hydraulic pump, a vacuum pump, etc., and is connected to the electrical motor through a driving-power-receiving shaft. The electrical motor uses electric energy to rotate the driving-power-receiving shaft to start the driving-power-outputting unit, so that the driving-power-outputting unit is operated to output driving power.

However, when the electrical motor directly starts the driving-power-receiving shaft of the driving-power-outputting unit, the driving-power-receiving shaft, initially, is rotated from a static state by the electrical motor. To start rotating the driving-power-receiving shaft, the electrical motor has to apply a force larger than the static friction force of the driving-power-receiving shaft, hence consuming more electrical power. Therefore, the conventional driving-power-outputting device consumes more electrical power to start the driving-power-outputting unit, and thus is not environmentally friendly and needs to be improved.

### SUMMARY OF THE INVENTION

The main objective of the present invention is to provide a driving-power-outputting flywheel device to resolve drawbacks that a conventional driving-power-outputting device consumes more electrical power to start the driving-power-outputting unit and thus is not environmentally friendly.

The driving-power-outputting flywheel device comprises a power-supply-and-controlling module, an electrical motor, a one-way transmission assembly, a flywheel assembly, and a driving-power-outputting unit. The power-supply-and-controlling module is connected to an electrical-power source. The electrical motor is electrically connected to the power-supply-and-controlling module and is controlled and charged by the power-supply-and-controlling module. The one-way transmission assembly comprises a motor-connecting shaft and a one-way bearing. The motor-connecting shaft is connected to the electrical motor. The one-way bearing is mounted at the motor-connecting shaft. The flywheel assembly comprises an assembling portion and an inertia outputting portion, which are disposed respectively at two opposite sides of the flywheel assembly. The assembling portion is connected to the one-way bearing. The flywheel assembly is axially rotatable relative to the electrical motor and is driven by the electrical motor through the one-way transmission assembly. The driving-power-outputting unit is connected to the inertia outputting portion of the flywheel assembly and is driven by the flywheel assembly.

The driving-power-outputting flywheel device reduces electrical power consumption of starting the driving-power-outputting unit because the one-way transmission assembly and the flywheel assembly are connected between the electrical motor and the driving-power-outputting unit. Specifically, the electrical motor is supplied with electrical power and is controlled by the power-supply-and-controlling module. The electrical motor drives the flywheel assembly to rotate through the one-way transmission assembly, the flywheel assembly hence starts inertial motions and stores energy. By using the energy stored by the flywheel assembly to start the driving-power-outputting unit, the electrical motor consumes less electrical power to operate the driving-power-outputting unit through the flywheel assembly. Therefore, power consumption of starting the driving-power-outputting unit is reduced and thus is more effective and environmentally friendly.

Besides, when an outputting rotational speed of the electrical motor drops so a rotational speed of the motor-connecting shaft is slower than a rotational speed of the flywheel assembly, the motor-connecting shaft cannot drive the flywheel assembly through the one-way bearing. Therefore, rotational motions of the flywheel assembly and the energy stored in the flywheel assembly will not be affected. The flywheel assembly can still store energy provided by the driving-power-outputting unit to contribute the driving-power-outputting unit to operate.

### BRIEF DESCRIPTION OF THE DRAWINGS

FIG. 1 is a perspective view of a driving-power-outputting flywheel device in accordance with the present invention;

FIG. 2 is a partially exploded view of the driving-power-outputting flywheel device in FIG. 1;

FIG. 3 is an exploded view of a driving-power-outputting unit, a flywheel assembly, and a one-way bearing of the driving-power-outputting flywheel device in FIG. 1;

FIG. 4 is an exploded view of the flywheel assembly and the one-way bearing of the driving-power-outputting flywheel device in FIG. 1;

FIG. 5 is a partially sectional side view of the driving-power-outputting flywheel device in FIG. 1;

FIG. 6 is a partially-enlarged sectional side view of the driving-power-outputting flywheel device in FIG. 1; and

FIG. 7 is a partially sectional front view of the driving-power-outputting flywheel device in FIG. 1.

### DETAILED DESCRIPTION OF THE PREFERRED EMBODIMENT

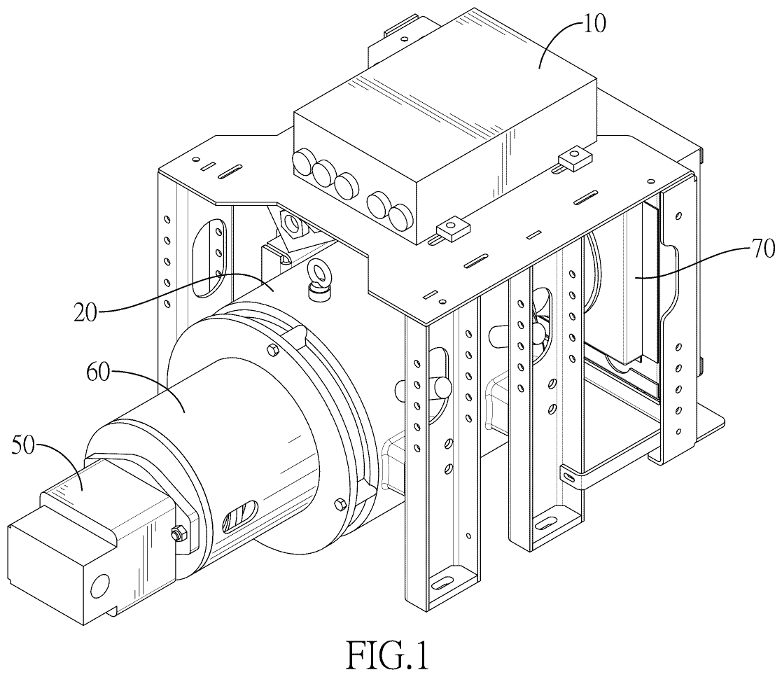

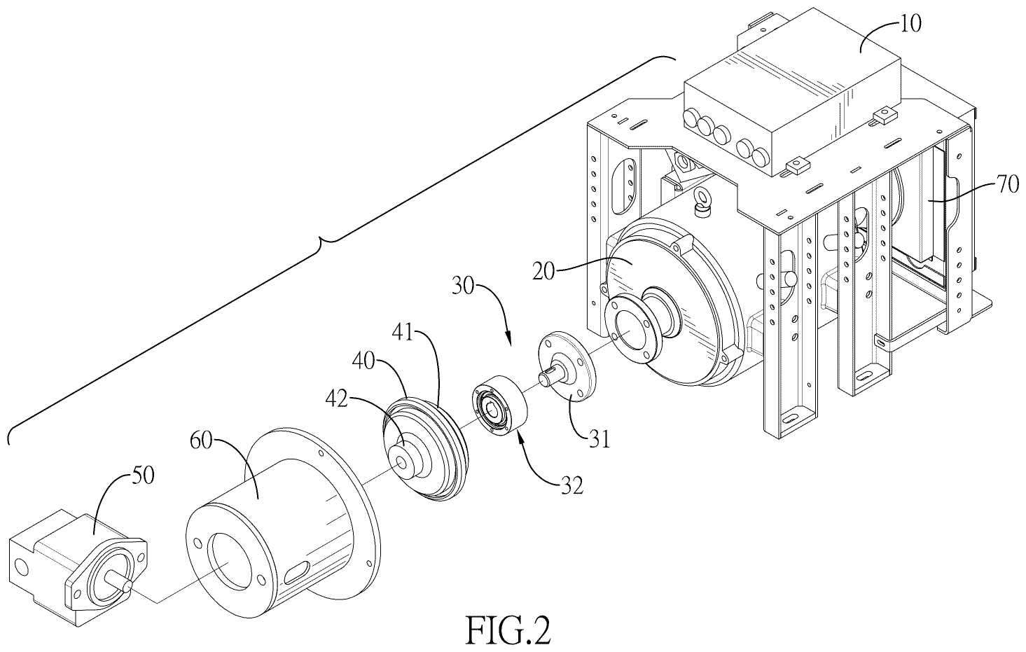

With reference to FIGS. 1 and 2, a driving-power-outputting flywheel device in accordance with the present invention comprises a power-supply-and-controlling module 10, an electrical motor 20, a one-way transmission assembly 30, a flywheel assembly 40 and a driving-power-outputting unit 50. The power-supply-and-controlling module 10 is connected to an electrical-power source.

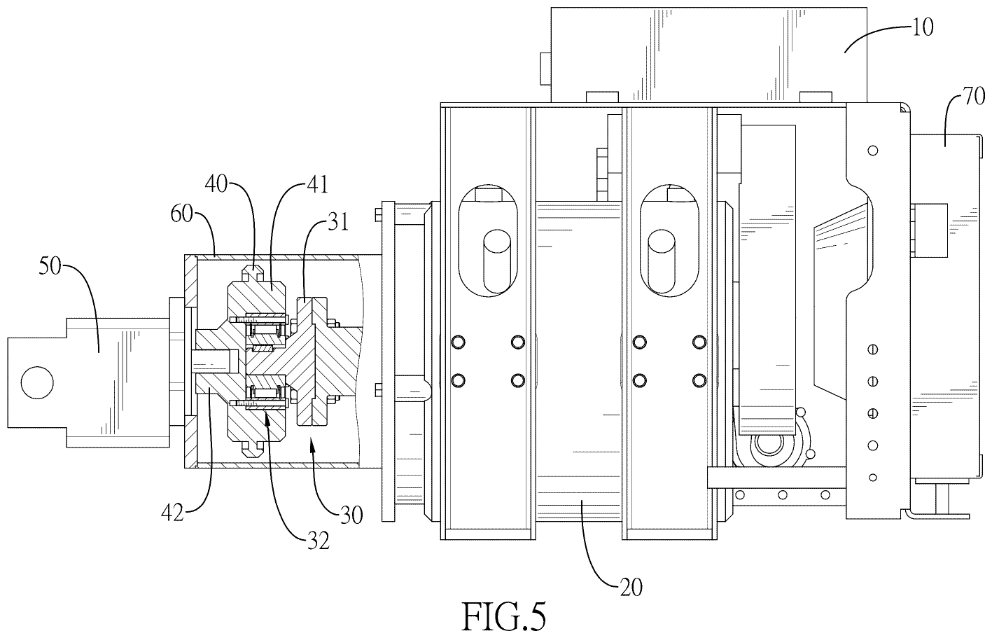

As shown in FIGS. 1 and 5, the electrical motor 20 is controlled by and is electrically connected to the power-supply-and-controlling module 10 to be charged by the power-supply-and-controlling module 10.

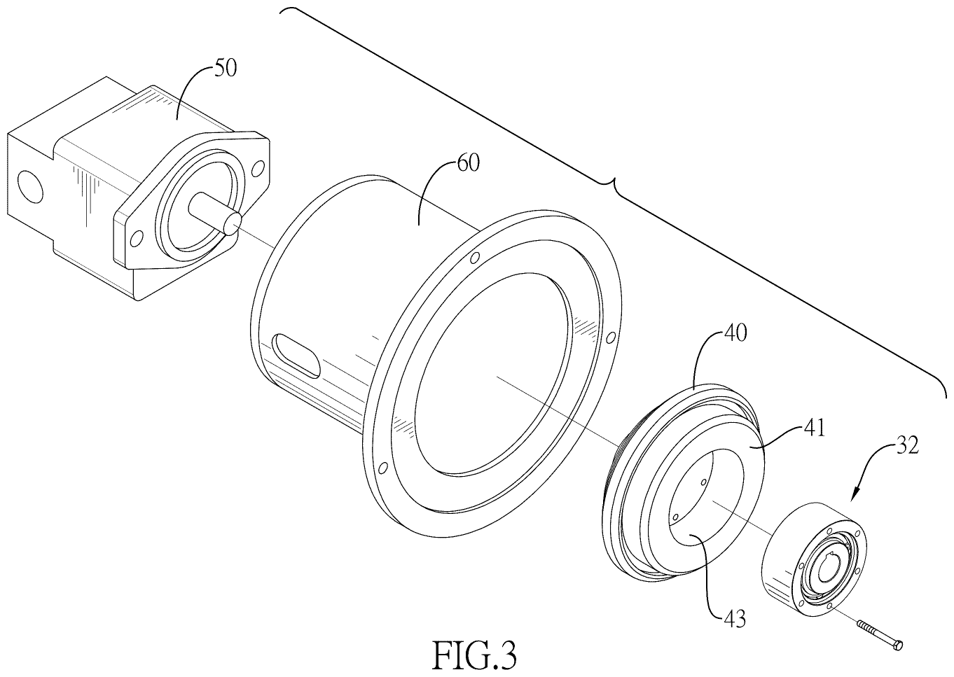

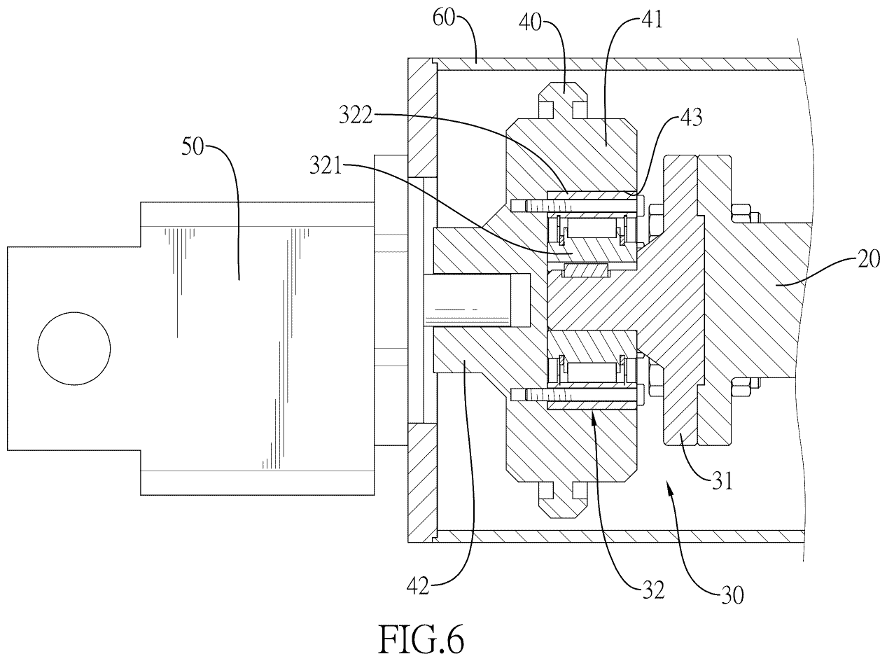

As shown in FIGS. 2, 3, 5 and 6, the one-way transmission assembly 30 comprises a motor-connecting shaft 31 and a one-way bearing 32. The motor-connecting shaft 31 is connected to the electrical motor 20. The one-way bearing 32 is mounted at the motor-connecting shaft 31.

As shown in FIGS. 2 to 6, the flywheel assembly 40 is disc-shaped and comprises an assembling portion 41 and an inertia outputting portion 42. The assembling portion 41 and the inertia outputting portion 42 are disposed respectively at two opposite sides of the flywheel assembly 40. The assembling portion 41 is connected to the one-way bearing 32. The flywheel assembly 40 is axially rotatable relative to the electrical motor 20 and is driven by the electrical motor 20 through the one-way transmission assembly 30.

As shown in FIGS. 2, 3, 5 and 6, the driving-power-outputting unit 50 is connected to the inertia outputting portion 42 of the flywheel assembly 40 and is driven by the flywheel assembly 40.

The driving-power-outputting flywheel device reduces electrical power consumption of starting the driving-power-outputting unit 50 because the one-way transmission assembly 30 and the flywheel assembly 40 are connected between the electrical motor 20 and the driving-power-outputting unit 50. Specifically, the electrical motor 20 is supplied with electrical power and controlled by the power-supply-and-controlling module 10. The electrical motor 20 drives the flywheel assembly 40 through the one-way transmission assembly 30, the flywheel assembly 40 hence starts inertial motions and stores energy. Then, the stored energy in the flywheel assembly 40 can be used to start the driving-power-outputting unit 50. Because a static friction force is larger than a kinetic friction force, starting the driving-power-outputting unit 50 from a static state requires a larger initial starting power. But the flywheel assembly 40 is constantly rotating, so, using the inertial motions of the flywheel assembly 40 can reduce initial starting power required, thereby reducing a starting current. Therefore, the electrical motor 20 consumes less electrical power to operate the driving-power-outputting unit 50 through the flywheel assembly 40, and thus power consumption of starting the driving-power-outputting unit is effectively reduced and thus is more effective and environmentally friendly.

Besides, while the driving-power-outputting unit 50 is operating to output driving power, the flywheel assembly 40 stores energy through the inertial motions, and thus to reduce a constant electrical-power requirement of the electrical motor 20 to drive the driving-power-outputting unit 50, thereby continuously saving electrical power. Furthermore, the inertia of the flywheel assembly 40 can be used to adjust an outputting torsional force of the electrical motor 20.

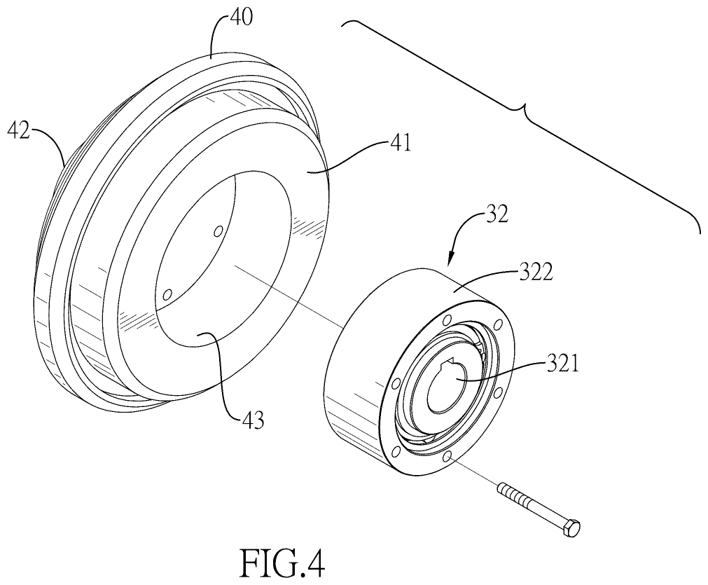

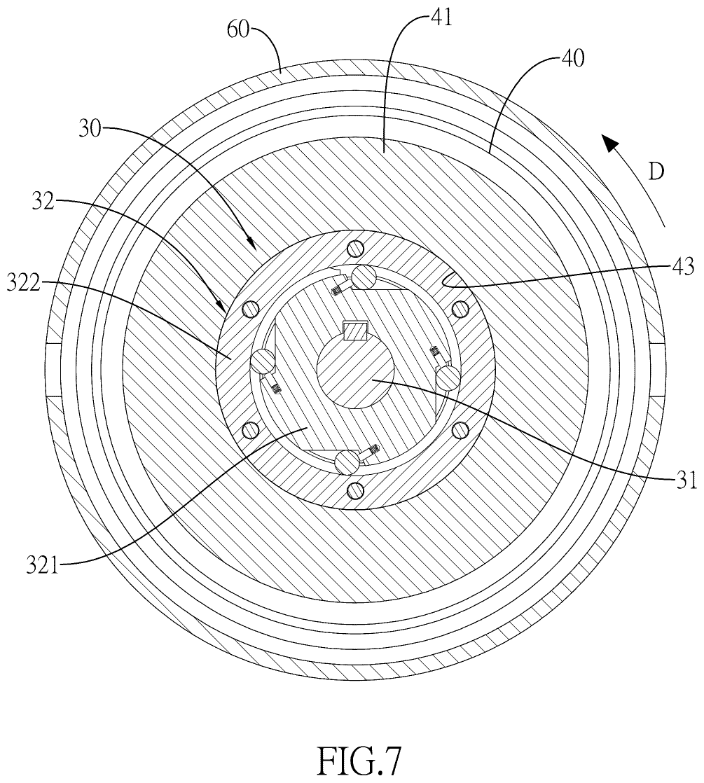

With reference to FIGS. 4 to 7, the assembling portion 41 of the flywheel assembly 40 comprises a containing recess 43. The one-way bearing 32 is mounted inside the containing recess 43 and comprises an inner ring 321 and an outer ring 322, which are rotatable relative to each other. The motor-connecting shaft 31 is connected to the inner ring 321 of the one-way bearing 32. The outer ring 322 of the one-way bearing 32 is connected to the flywheel assembly 40. When rotating along a driving direction D, the motor-connecting shaft 31 drives the flywheel assembly 40 to rotate through the one-way bearing 32. When an outputting rotational speed of the electrical motor 20 drops so a rotational speed of the motor-connecting shaft 31 is slower than a rotational speed of the flywheel assembly 40, the motor-connecting shaft 31 rotates opposite to the driving direction D relative to the flywheel assembly 40. At this time, the motor-connecting shaft 31 cannot drive the flywheel assembly 40 through the one-way bearing 32. Therefore, rotational motions of the flywheel assembly 40 and the energy stored in the flywheel assembly 40 will not be affected. The flywheel assembly 40 still can store energy provided by the driving-power-outputting unit 50, to contribute to operation of the driving-power-outputting unit 50. In addition, the one-way bearing 32 shown in the drawings is only used to elaborate how the one-way bearing 32 works and does not limit configurations of the one-way bearing 32. Other configurations of one-way bearings can also be adopted to the present invention.

As shown in FIGS. 1 to 3, the driving-power-outputting flywheel device comprises a protecting cover 60 mounted at the electrical motor 20. The one-way transmission assembly 30 and the flywheel assembly 40 are disposed inside the protecting cover 60. The driving-power-outputting unit 50 is mounted at a side, being away from the electrical motor 20, of the protecting cover 60. The driving-power-outputting unit 50 extends into the protecting cover 60 to connect the flywheel assembly 40. The protecting cover 60 protects the one-way transmission assembly 30 and the flywheel assembly 40 to prevent external objects interfering with operations of the driving-power-outputting flywheel device.

Furthermore, the power-supply-and-controlling module 10 is preferably mounted at the electrical motor 20, so that the driving-power-outputting flywheel device is a compact design overall.

Preferably, the electrical-power source is a solar-power module.

Supplying electrical power to the power-supply-and-controlling module 10 through solar power benefits the driving-power-outputting flywheel device to be more environmentally friendly. Additionally, because the solar-power module generates direct-current electrical power, so the power can be directly supplied to the power-supply-and-controlling module 10 without using an external converter to convert alternating current to direct current, and thus further saving costs and a required space for converters.

As shown in FIGS. 1 and 5, the driving-power-outputting flywheel device comprises an electrically-cooling module 70 mounted to the electrical motor 20, electrically connected to the power-supply-and-controlling module 10, and controlled by the power-supply-and-controlling module 10 to cool down the electrical motor 20 to reduce a heat waste of the electrical motor 20.

Additionally, an oil hydraulic pump of a conventional garbage-recycling truck is driven by a motor. If the motor is connected to a battery pack of the garbage-recycling truck and directly drives the oil hydraulic pump to operate, a starting current of the oil hydraulic pump is high, and hence consuming a lot of power, having to connect a large battery pack and occupying more space. Besides, a high torsional force is required to start oil hydraulic pump so the motor is large-sized and heavy. Moreover, in other conditions, the motor is connected to an engine gearbox of the garbage-recycling truck through a transmitting shaft and a power-divided transmitting device, and drives the oil hydraulic pump to operate with energy generated by an engine in idle. The motor, the transmitting shaft and the power-divided transmitting device compose a whole structure that is heavy in weight and complicated in structure, hence, a power waste in transmission is higher, taking more space, and so occupying a whole truck space design. When the driving-power-outputting flywheel device is applied to a garbage-recycling truck, the oil hydraulic pump of the garbage-recycling truck is equivalent to the driving-power-outputting unit 50. The power-supply-and-controlling module 10 is electrically connected to a battery and is powered by the battery. The electrical motor 20 of the driving-power-outputting flywheel device only consumes little electrical power to operate the oil hydraulic pump through the flywheel assembly 40 without complicated structures, reducing a weight and an occupied volume of the driving-power-outputting flywheel device, therefore is conducive for the whole truck space design.

Furthermore, the driving-power-outputting flywheel device can be applied to fixed-point trash compressors. The driving-power-outputting unit 50 is a hydraulic pump and is used to compress trash. The fixed-point trash compressor is more suitable for adopting the solar-power module to make garbage recycling industry more environmentally friendly.

Preferably, the driving-power-outputting unit 50 is a hydraulic pump. Alternatively, the driving-power-outputting unit 50 can be a vacuum pump, a water pump, or a heavy-duty generator according to users' needs. For example, when the driving-power-outputting flywheel device is applied to a garbage-recycling truck or an elevator, the driving-power-outputting unit 50 is optionally an oil hydraulic pump. When the driving-power-outputting flywheel device is applied to a slurry truck, a suction truck or aquaculture, the driving-power-outputting unit 50 is optionally a water pump. When the driving-power-outputting flywheel device is applied to an emergency power supply vehicle, a tunnel fire truck or a power-balancing device, the driving-power-outputting unit 50 is optionally a heavy-duty generator.

To sum up, the one-way transmission assembly 30 and the flywheel assembly 40 of the driving-power-outputting flywheel device are connected between the electrical motor 20 and the driving-power-outputting unit 50. The electrical motor 20 drives the flywheel assembly 40 to rotate through the one-way bearing 32 of the one-way transmission assembly 30, so that the flywheel assembly 40 starts inertial motions and stores energy. Therefore, when starting the driving-power-outputting unit 50, pre-stored energy in the flywheel assembly 40 reduces the starting current to reduce power consumption for starting the driving-power-outputting unit 50, thereby saving electrical power and being environmentally friendly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A driving-power-outputting flywheel device comprising:
a power-supply-and-controlling module connected to an electrical-power source;
an electrical motor electrically connected to the power-supply-and-controlling module, charged by and controlled by the power-supply-and-controlling module;
a one-way transmission assembly comprising
a motor-connecting shaft connected to the electrical motor;
a one-way bearing mounted at the motor-connecting shaft;
a flywheel assembly comprising
an assembling portion and an inertia outputting portion disposed respectively at two opposite sides of the flywheel assembly; the assembling portion connected to the one-way bearing; the flywheel assembly being axially rotatable relative to the electrical motor, and driven by the electrical motor through the one-way transmission assembly; and
a driving-power-outputting unit connected to the inertia outputting portion of the flywheel assembly and driven by the flywheel assembly.

2. The driving-power-outputting flywheel device as claimed in claim 1, wherein
the assembling portion of the flywheel assembly comprises
a containing recess;
the one-way bearing is mounted in the containing recess and comprises
an inner ring and an outer ring being rotatable relative to each other;
the motor-connecting shaft is connected to the inner ring of the one-way bearing;
the outer ring of the one-way bearing is connected to the flywheel assembly; and
when rotating along a driving direction, the motor-connecting shaft drives the flywheel assembly to rotate through the one-way bearing.

3. The driving-power-outputting flywheel device as claimed in claim 1, wherein
the driving-power-outputting flywheel device comprises
a protecting cover mounted at the electrical motor;
the one-way transmission assembly and the flywheel assembly are disposed inside the protecting cover;
the driving-power-outputting unit is mounted at a side, being away from the electrical motor, of the protecting cover and extends into the protecting cover to connect the flywheel assembly.

4. The driving-power-outputting flywheel device as claimed in claim 2, wherein
the driving-power-outputting flywheel device comprises
a protecting cover mounted at the electrical motor;
the one-way transmission assembly and the flywheel assembly are disposed inside the protecting cover;
the driving-power-outputting unit is mounted at a side, being away from the electrical motor, of the protecting cover and extends into the protecting cover to connect the flywheel assembly.

5. The driving-power-outputting flywheel device as claimed in claim 1, wherein the driving-power-outputting unit is a hydraulic pump.

6. The driving-power-outputting flywheel device as claimed in claim 4, wherein the driving-power-outputting unit is a hydraulic pump.

7. The driving-power-outputting flywheel device as claimed in claim 1, wherein the power-supply-and-controlling module is mounted to the electrical motor.

8. The driving-power-outputting flywheel device as claimed in claim 6, wherein the power-supply-and-controlling module is mounted to the electrical motor.

9. The driving-power-outputting flywheel device as claimed in claim 1, wherein the electrical-power source is a solar-power module.

10. The driving-power-outputting flywheel device as claimed in claim 8, wherein the electrical-power source is a solar-power module.

11. The driving-power-outputting flywheel device as claimed in claim 1, wherein the driving-power-outputting flywheel device comprises an electrically-cooling module mounted at the electrical motor, electrically connected to the power-supply-and-controlling module, and controlled by the power-supply-and-controlling module to cool down the electrical motor.

12. The driving-power-outputting flywheel device as claimed in claim 10, wherein the driving-power-outputting flywheel device comprises an electrically-cooling module mounted at the electrical motor, electrically connected to the power-supply-and-controlling module, and controlled by the power-supply-and-controlling module to cool down the electrical motor.
